(19) United States
(12) Patent Application Publication
(10) Pub. No.: US 2017/0111658 A1
(43) Pub. Date: Apr. 20, 2017

(54) IMAGE CAPTURE AND TRANSMISSION SYSTEM

(71) Applicant: ALCATEL-LUCENT USA INC., Murray Hill, NJ (US)

(72) Inventors: Hong JIANG, Warren, NJ (US); Gang HUANG, Monroe Twp, NJ (US); Willie PADILLA, Cary, NC (US)

(21) Appl. No.: 14/886,594

(22) Filed: Oct. 19, 2015

(51) Int. Cl. H04N 19/64; H04N 19/132

(52) U.S. Cl. CPC H04N 19/64; H04N 19/132

(57) ABSTRACT

An illustrative example embodiment of an image acquisition and communication device includes a programmable mask including a plurality of aperture elements. The aperture elements are controllable to establish a plurality of patterns for modulating signal energy associated with an image. The patterns provide a corresponding plurality of signal energies transmitted by the programmable mask. At least one detector produces an analog signal based on the plurality of signal energies. A transmitter is configured to transmit the analog signal.

### BACKGROUND

This invention generally relates to image acquisition and communication. More particularly, but without limitation, this invention relates to processing image information for wireless transmission.

There are various situations in which transmitting image information over wireless communication channels is desired. Known techniques include using image compression to reduce the bandwidth consumed by transmitting image information over a wireless channel. One of the disadvantages associated with using compression techniques such as JPEG is that they reduce image quality. There are various other disadvantages associated with known techniques.

Some known techniques rely upon analog-to-digital conversion followed by digital-to-analog conversion. One disadvantage to using such conversion is that it consumes a relatively large amount of power. In many instances, it is desirable to avoid such power consumption to preserve battery life or for other reasons.

Another aspect of analog-to-digital conversion techniques is that they introduce quantization noise that may not be optimal for a dynamic wireless channel. Additionally, known compression techniques may not be optimal for a dynamic wireless channel. Dynamic wireless channels tend to have different levels of noise and interference that vary over time. Such noise or interference may prevent reception of portions of transmitted image information in such a way that the entire image transmission is effectively lost. If the quantization or compression is such that the transmitted bit stream exceeds the wireless channel capacity, it is not possible to generate and observe the image at the receiving equipment because less than all of the bits are received. In some instances if even a few bits are missing the entire transmitted image is effectively lost.

There is a need for reliable and efficient communication of image information over wireless channels.

### SUMMARY

An illustrative example embodiment of an image acquisition and communication device includes a programmable mask including a plurality of aperture elements. The aperture elements are controllable to establish a plurality of patterns for modulating signal energy associated with an image. The patterns provide a corresponding plurality of signal energies transmitted by the programmable mask. At least one detector produces an analog signal based on the plurality of signal energies. A transmitter is configured to transmit the analog signal.

An illustrative example embodiment of a method of communicating image information includes selectively modulating signal energy associated with an image resulting in a plurality of signal energies; generating an analog signal based on the signal energies; and transmitting the analog signal.

An illustrative example embodiment of an image generator device includes a receiver configured to receive an analog signal corresponding to an image, an extractor module configured to extract a plurality of image coefficients the correspond to signal energies from the received analog signal; and a transformation module configured to transform the plurality of image coefficients into a plurality of image pixel values.

Various features and advantages of at least one disclosed embodiment will become apparent to those skilled in the art from the following detailed description. The drawings that accompany the detailed description can be briefly described as follows.

### BRIEF DESCRIPTION OF THE DRAWINGS

FIG. 1 schematically illustrates an image processing and transmitting system designed according to an embodiment of this invention.

FIG. 2 schematically illustrates an image processing device designed according to an embodiment of this invention.

FIG. 3 schematically illustrates a selected feature of a wireless transmission utilized in an example embodiment of this invention.

FIG. 4 schematically illustrates another wireless transmission technique used in an embodiment of this invention.

FIG. 5 schematically illustrates another example embodiment of an image processing device designed according to an embodiment of this invention.

FIG. 6 is a flowchart diagram summarizing an example image processing and communicating technique.

### DETAILED DESCRIPTION

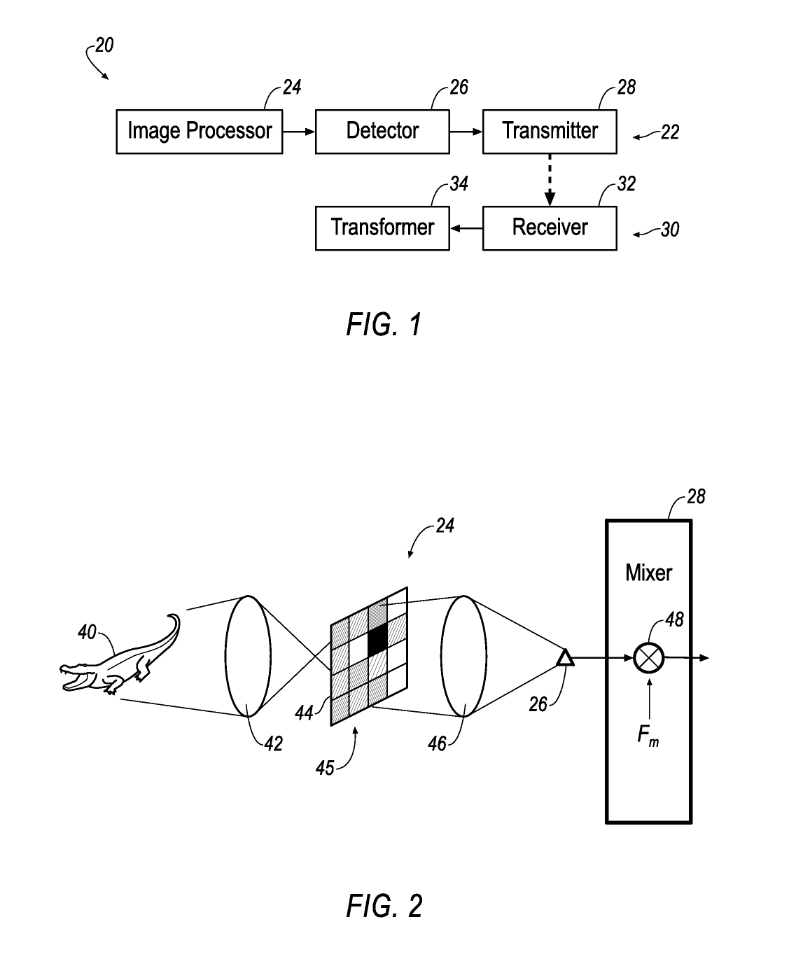

FIG. 1 schematically shows an image processing and communicating system 20 that facilitates communicating image information over wireless communication channels in an efficient and reliable manner. An image capturing and transmitting device 22 includes an image processor 24, which includes a programmable mask in this example, that modulates light or another signal energy from the scene to be imaged. The programmable mask consists of an array of elements, each of which has a transmittance that can be changed individually. When the elements of the mask are programmed to have certain transmittance, a pattern is created on the mask. A detector 26 detects the light or signal energy from the scene passing through the programmed mask and converts the energy into an analog signal. For each programmed pattern on the mask, the value of signal energy (e.g., light) detected by the detector 26 represents or corresponds to an image coefficient. When a sequence of patterns is created on the mask, the analog signal from the detector 26 is the analog waveform of the image coefficients corresponding to the sequence of the patterns of the mask. A transmitter 28 wirelessly transmits the analog signal to a remotely located image receiving and processing device 30.

A receiver 32 receives the analog signal over a wireless channel. The receiver 32 extracts the image coefficients from the received analog signal. A transformer 34 transforms the image coefficients from the received signal into a plurality of received image pixel values. Usually, the image pixel values are created from the received image coefficients by a reconstruction process in which a solution to a minimization problem is found.

FIG. 2 schematically illustrates an example image capturing and transmitting device 22. In this example, the image processor 24 includes components capable of modulating a signal, such as light or a THz wave, from a scene or an object of interest 40. The example image processor 24 includes a first lens 42, a programmable mask including an array of aperture elements 44 that each has a transmittance allowing or blocking the signal from the corresponding portion of the image to pass through the mask, and a second lens 46. The aperture elements 44 may include a plurality of shutter elements, mask portions or meta-materials that are controllable for allowing signal, such as light or a THz wave, transmission for detection by the detector 26. Controlling the aperture elements provides control over which portion of the signal, such as light or THz wave, from the scene that is imaged is incident on the detector 26.

The signal from the scene to be imaged can be visible light, or any signal of other spectra, such as, but not limited to, infrared (IR), terahertz (THz) wave, millimeter (mm) wave, or X-ray.

One embodiment of the image processor 24 includes a programmable mask 45 having the plurality of aperture elements 44. In such an example, the mask 45 comprises an array of individually controllable aperture elements 44 that are controllable to provide different levels of light transparency. The example mask 45 is programmable to establish a plurality of patterns of the aperture elements 44. Utilizing multiple patterns modulates light associated with an image as detected and processed by the device 22.

There are known reconfigurable multiplex imaging masks that are useful for this purpose. Those skilled in the art who wish to implement such an embodiment will be able to utilize known information regarding available masks to select or develop an appropriate configuration to meet their particular needs. For example, the mask could be made of a liquid crystal display (LCD), an array of micromirrors, or meta-materials.

Each of the aperture elements 44 provides a value to control the amount of light or other signal energy passing through that aperture element, which is based on how that aperture element is controlled and the content of a corresponding portion of the image. For example, in a gray scale-based embodiment the aperture values may have a value between 0 and 255.

In the example of FIG. 2, the mask 45 is programmable to implement a transform matrix, also called a sensing matrix or measurement matrix, for generating a sequence of patterns on the mask by controlling the aperture elements 44. One example of a transform matrix includes using a known permutated Hadamard matrix. The transmittance of the elements of the mask 45 is programmed according to the values of the transform matrix. Each row of the transform matrix has n values, and each of the n values is used to program the corresponding one of the n elements 44 in the mask 45, so that the transmittance of the element 44 corresponds to the value of the row. Therefore, each row of the transform matrix defines a pattern in the mask 45, and all rows of the transform matrix define a sequence of patterns of the aperture elements 44 of the mask 45.

In the example of FIG. 2, sixteen aperture elements 44 are schematically shown as part of the mask 45 for discussion purposes. Most embodiments will include many more aperture elements than those schematically shown. With the illustrated sixteen aperture elements (n=16), a transform matrix, such as what is formed by m rows of a 16×16 permutated Hadamard matrix, may be of dimension m×16 for creating m patterns of the sixteen aperture values, where m is less than or equal to 16. The image processor 24 in this example generates m patterns in the mask 45, each allowing a different amount of the signal (e.g., light) from different portion of the scene to pass through the mask 45. The signal (e.g., light) passing through the mask 45 will be detected by the detector 26, so that each pattern in the mask will cause the detector 26 to have a corresponding value. A sequence of patterns in the mask will transmit respective amounts of signal energy that cause the detector 26 to generate a corresponding sequence of values or magnitudes of an analog signal. The sequence of signal energies can be considered or referred to as image coefficients.

The image coefficients can also be called measurements, corresponding to the transform matrix that is used for controlling the programmable mask 45. In the example of FIG. 2, an m×16 transform matrix will cause the detector 26 to generate m measurements, or m image coefficients. Usually, m is smaller than 16, so that the number of the image coefficients, or measurements, which is m, is smaller than the number of aperture elements in the mask, which is 16. This means that the image of 16 pixels is captured with m image coefficients, and therefore, the captured image is compressed. For example, if m=8, then, there is only half as many image coefficients as the number of image pixels 16, and hence only 50% of image coefficients are made, in which case, the compression ratio or factor is 2. If m=4, then only 25% of image coefficients are made and the compression ratio is 4.

One way in which the device 22 differs from many imaging devices is that the device 22 effectively captures the plurality of image coefficients rather than capturing an image of discrete pixels. The image coefficients are captured by the detector 26 in the form of an analog signal for transmission over a wireless communication channel, for example.

The detector 26 generates a wave form based on the amount of light passing through the mask, which is in turn based on the scene to be imaged and the programmed patterns of the mask. This wave form is the analog signal modulated by the image coefficients for the corresponding scene and the mask patterns. The detector 26 is configured to detect energy of the wave field generated by the image processor 24. The output of the detector 26 is an analog electric signal of the image coefficients that corresponds to the energy associated with the amount of light or signal energy passing through the mask 45. In one example, the image coefficients are represented by a voltage corresponding to the intensity of light. In some embodiments, the detector 26 comprises a photodiode, a photovoltaic cell or a bolometer.

In this example, the detector 26 generates an electrical analog signal having an amplitude corresponding to the magnitude of the sequence of image coefficients. In this example, the magnitude of the image coefficients corresponds to the intensity of light associated with the different patterns of the programmable mask 45. The image coefficients may each correspond to a voltage of the detected light. The detector 26 converts that voltage or intensity of light represented by the coefficients into a voltage of the analog signal.

The transmitter 28 performs analog signal processing to prepare the output signal from the detector 26 to be suitable for wireless transmission according to a selected transmitting strategy. In the illustrated example, the transmitter 28 includes a mixer to convert the signal from the detector 26 to an appropriate carrier frequency. Other portions of the transmitter 28 may include a filter to shape the spectrum of the signal to be suitable for wireless transmission. An amplifier is useful for adjusting the transmission power and an antenna may be used for the actual transmission.

Frequency division modulation is used in one example to transmit some of the portions of the analog signal corresponding to some of the image coefficients at one selected frequency and transmitting at least one other portion of the analog signal at a second, different selected frequency. Utility different frequencies for the transmission of different portions of the analog signal facilitates ensuring that at least some portions of the signal will be usable by the receiver 32 for generating the image. In an example with eight image coefficients, the transmitter 28 utilizes eight time slots for transmitting the modulated analog signal.

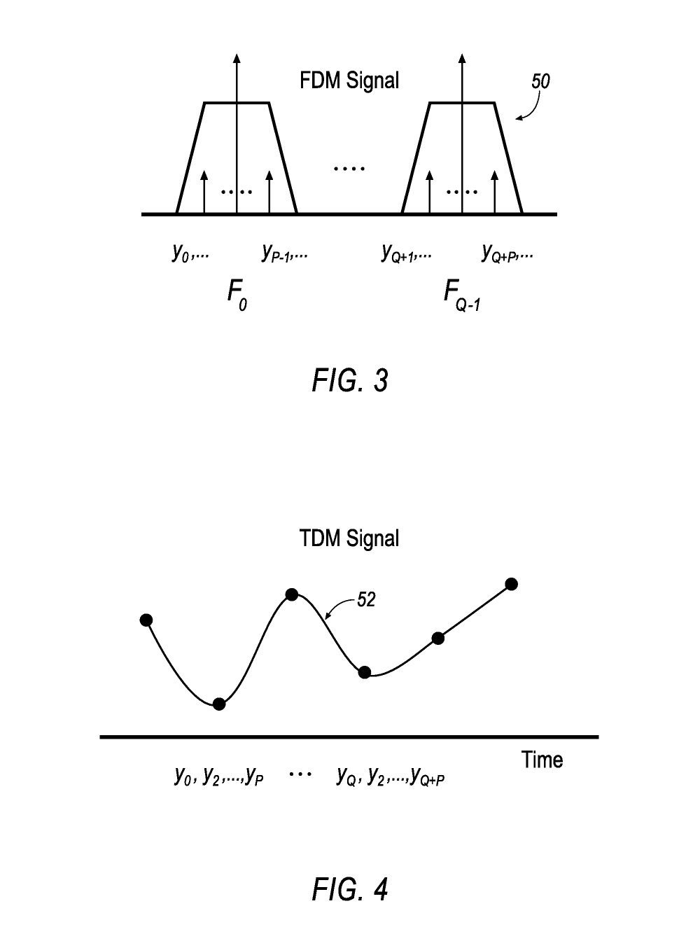

FIG. 3 schematically illustrates an example modulating technique for transmitting the analog signal containing the image information. Different frequencies are selected as schematically shown by the plot 50 for transmitting different portions of the analog signal corresponding to different ones of the image coefficients. Utilizing different frequencies for transmitting different portions of the signal accommodates varying signal conditions. One situation in which the image processing and wireless transmission techniques of the example embodiment are useful is for a surveillance drone communicating a stream of images to a remote location. It is not possible to predict the channel conditions or changes in the environment in the vicinity of such a drone. If there is significant interference at a particular frequency, that can be avoided by utilizing different frequencies or frequency hopping as a modulating technique for transmitting the signal.

FIG. 4 schematically illustrates another modulating technique as represented by the plot 52. In this example, a time division multiplexing technique is used for transmitting the analog signal for purposes of avoiding poor channel conditions for the reasons mentioned above. Another modulation technique combines frequency and time division multiplexing.

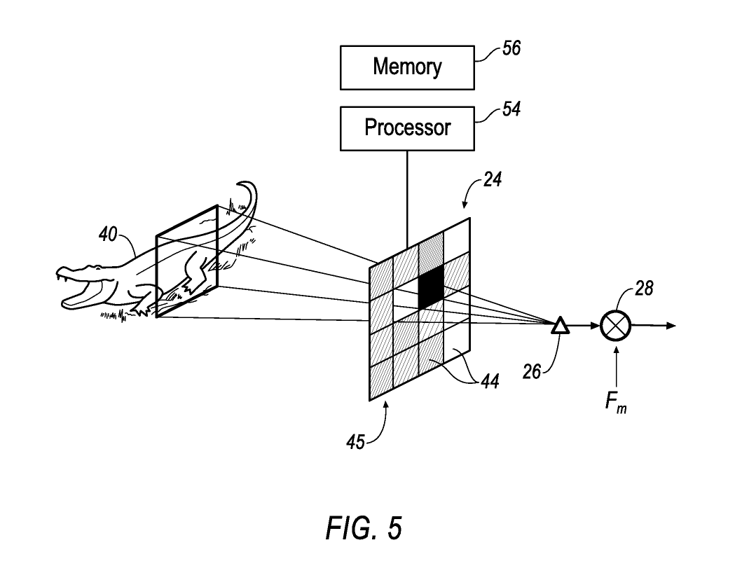

FIG. 5 schematically represents another example embodiment of an image capturing and transmitting device 22. In this example, the image processor 24 includes a lensless compressive image acquisition device. The plurality of aperture elements 44 may be a micro-mirror array or an LCD shutter matrix, for example. An example of such a device is described in the pending U.S. patent application Ser. No. 13/658,900, filed Oct. 24, 2012. That application is incorporated into this description by reference.

A processor 54 controls operation of the aperture elements 44 during image capture. A memory portion 56 associated with the processor 54 may be used for storing information about the transform matrix (also called a sensing matrix or measurement matrix) and instructions to be executed by the processor 54 during image capture. In this example embodiment, the processor 54 is suitably programmed to control the aperture elements 44 to establish a plurality of mask patterns according to a transform matrix like some selected rows of a permutated Hadamard matrix for generating the plurality of image coefficients. Otherwise, the example embodiment of FIG. 5 includes a detector 26 and a transmitter 28 like those described above.

In one example embodiment, each aperture element is programmed to have a transmittance corresponding to a value in a row of the transform matrix. If an m×n transform matrix H is used, there are m rows in the matrix H, and each row has n values, where n is the number of elements 44 in the mask 45. For each row in H, a pattern can be created for the aperture elements of the mask. The pattern is created by programming an element of the mask to have the transmittance given by the value of the corresponding entry in the row of the matrix H. For each row of the matrix H, a pattern is created, and for each pattern, the detector 26 detects the total amount of light or signal energy passing through the mask 45, and provides a value corresponding to the given pattern. The value from the detector 26 is the image coefficient corresponding to the scene and the given pattern. Therefore, the transform matrix H defines m patterns for the mask, and hence provides m values or image coefficients from the detector 26. Usually, m<n, that is, there are fewer image coefficients (m) than the number (n) of aperture elements 44, which is the same as the number of pixels in the image. Since the number of image coefficients m is smaller than the number of pixels n, the compressed data is captured by the device. In the example of FIG. 5, there are sixteen aperture elements 44, and therefore, n=16. The total number of image coefficients, or detector measurements, is m, which can be chosen to be m=8, or m=4 etc, for 50% or 25% of image coefficients, respectively. For m=8, or 4, the compression ratio is 2 or 4, respectively.

The signal from the scene to be imaged can be visible light, or any signal of other spectra, such as, but not limited to, infrared (IR), terahertz (THz) wave, millimeter (mm) wave, or X-ray.

Let x be the vector of image pixels, then x is a vector of length n. Let y be the vector of image coefficients, then y is a vector of length m. Image coefficients created by using the transform matrix H as described above satisfy the relationship,

y=Hx (Eq. 1).

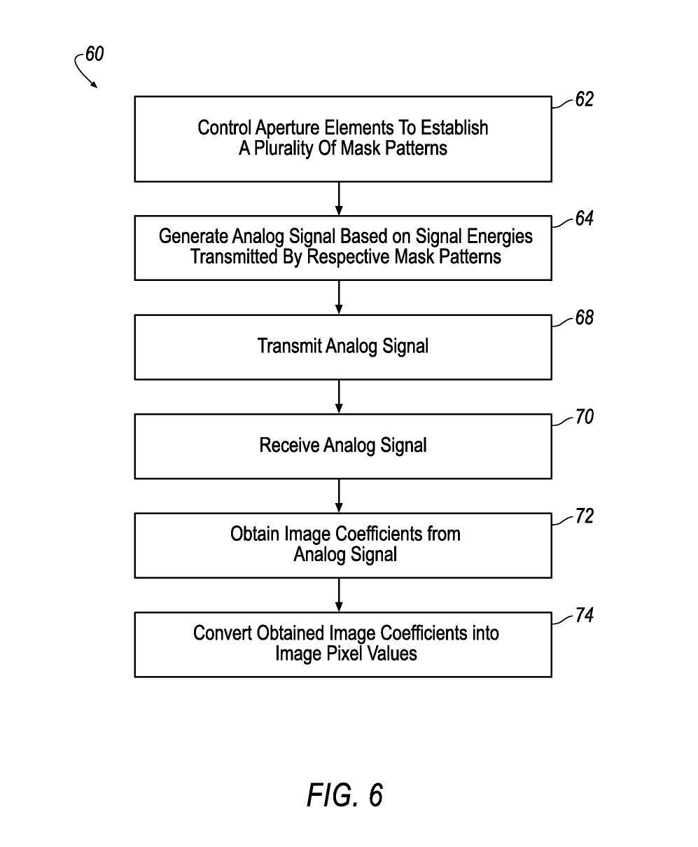

FIG. 6 is a flowchart diagram 60 summarizing an example approach. At 62, the aperture elements 44 are controlled to establish a plurality of mask patterns, At 64, the detector 26 detects the total amount of light passing through the mask resulting from each pattern and generates a waveform which is the analog modulated signal of the signal energies passing through the mask 45. The analog signal has an amplitude that corresponds to the values of the image coefficients. At 68, the transmitter 28 transmits the analog signal, including using frequency modulation to reduce the effects of interference or poor channel conditions on any particular frequency. The steps 62-68 are performed by the image capturing and transmitting device 22. The rest of the flow chart 50 schematically represents steps performed by a receiving device 30.

At 70, the analog signal is received by the receiver 32. At 72, the receiver 32 obtains the image coefficients from the received analog signal. In some instances, not all of the image coefficients are received because of interference or poor channel conditions. Having less than all of the image coefficients, however, does not prevent generating or utilizing the image information at the receiver device 30. In this example an image can be reconstructed by using the received image coefficients even if less than all image coefficients are available to the receiver.

At 74, the image coefficients are converted by the transformer 34 into received image pixel values. Various methods exist to convert the received image coefficients y to image pixel values x, which are also called reconstruction methods. For example, after the image coefficients y are received the vector of the image pixels x can be solved based on Equation 1, in which H is the transform matrix used at 62 to control the mask 45, which results in the image coefficients. The transform matrix H is known to the receiving and processing device 30, either because it is previously agreed to by the capturing and transmitting device 22 and the receiving and processing device 30, or because the information regarding how to generate H is transmitted to the receiving and processing device 30 by the capturing and transmitting device 22. In any case, there is no need to transmit every value of the transform matrix H. To the extent that Equation 1 is underdetermined (e.g., there are more unknowns than the number of equations) it can be solved, for example, by a minimization process which is well known in the art.

The example illustrated embodiments allow for compressive image sensing techniques to be used and for data compression that does not compromise the quality of the image. The image capturing technique resulting in the image coefficients and transmission of those coefficients using an analog signal allows for avoiding the drawbacks and limitations associated with some compression techniques. Additionally it is possible to reconstruct the transmitted image without receiving every image coefficient. It is therefore possible with the example embodiments to reconstruct an image utilizing received signals that contain less than all of the image information that was intended to be transmitted and received. There are known techniques for how to recover an entire image when less than all of the information has been received. Such techniques are useful in an embodiment of this invention.

For example, if a one megapixel image is compressed using JPEG compression techniques and transmitted using OFDM, a receiver may demodulate the received signal to obtain the image. If even a few of the bytes of the JPEG transmission are not accurately received, however, in many instances it is impossible to recreate or generate the image. With the illustrated example embodiments of this invention, on the other hand, receiving or decoding less than all of the coefficients at the receiver device 30 does not prevent image generation.

Furthermore, the example illustrated embodiments reduce power consumption because no digital circuit is used to process the image or image coefficients in the capturing and transmitting device 22. In particular, no analog to digital converter (ADC) or digital to analog converter (DAC) are used in the capturing and transmitting device 22. The use of digital circuits, such as ADC or DAC usually consumes a large amount of power. Therefore, an advantage of the capturing and transmitting device 22 is that it can be low power and is suitable as a portable sensor.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An image processing device, comprising:
a programmable mask including a plurality of aperture elements, the aperture elements being controllable to establish a plurality of patterns, the plurality of patterns providing a corresponding plurality of signal energies transmitted by the programmable mask;
at least one detector that produces an analog signal based on the plurality of signal energies; and
a transmitter that is configured to transmit the analog signal.

2. The device of claim 1, wherein each of the signal energies corresponds to an image coefficient that corresponds to a respective one of the plurality of patterns.

3. The device of claim 1, wherein the programmable mask comprises a first lens on one side of the aperture elements and a second lens on another side of the aperture elements.

4. The device of claim 1, comprising at least one processor and a memory associated with the processor, the memory containing instructions executed by the processor for controlling the plurality of aperture elements.

5. The device of claim 1, wherein
the aperture elements are controlled based on an m×n transform matrix H;
there are m rows in the matrix H;
each row has n values;
there are n aperture elements 44;
each row in H establishes a pattern for the aperture elements;
the detector detects the respective signal energies passing through the mask resulting from the patterns respectively;
the detector provides m signal energy values; and
a magnitude of the analog signal corresponds to the m signal energy values.

6. The device of claim 5, wherein m<n.

7. The device of claim 1, comprising a lensless compressive imaging device.

8. The device of claim 1, wherein the analog signal has an amplitude that corresponds to a magnitude of the signal energies.

9. The device of claim 7, wherein the detector comprises at least one of a photo diode, a photovoltaic cell, or a bolometer.

10. The device of claim 1, wherein
the transmitter comprises a modulator that modulates the analog signal;
the modulator selects at least one frequency for transmission of the analog signal.

11. The device of claim 10, wherein
the modulator varies the selected frequency;
the modulator uses a first frequency for a first portion of the analog signal corresponding to a first one of the signal energies; and
the modulator uses a second, different frequency for a second portion of the analog signal corresponding to a second one of the signal energies.

12. The device of claim 1, wherein the signal energies comprise at least one of
light,
infrared radiation,
terahertz radiation,
millimeter wave radiation, and
X-ray radiation.

13. A method of communicating image information, comprising:
selectively modulating signal energy associated with an image resulting in a plurality of signal energies;
generating an analog signal based on the signal energies; and
transmitting the analog signal.

14. The method of claim 13, wherein the analog signal has an amplitude that corresponds to a magnitude of the signal energies.

15. The method of claim 13, wherein transmitting the analog signal comprises
modulating the analog signal using at least one selected frequency for transmitting the analog signal.

16. The method of claim 15, comprising varying the selected frequency by
using a first frequency for a first portion of the analog signal corresponding to a first one of the signal energies; and
using a second, different frequency for a second portion of the analog signal corresponding to a second one of the signal energies.

17. The method of claim 13, comprising
receiving the transmitted analog signal;
obtaining image coefficients from the signal energies of the received analog signal;
transforming the obtained image coefficients into a corresponding plurality of received image pixel values; and
obtaining a representation of the image from the plurality of received image pixel values.

18. The method of claim 13, wherein the signal energies comprise at least one of
light,
infrared radiation,
terahertz radiation,
millimeter wave radiation, and
X-ray radiation.

19. An image generator device, comprising:
a receiver configured to receive an analog signal corresponding to an image;
an extractor module configured to extract a plurality of image coefficients the correspond to signal energies from the received analog signal; and
a transformation module configured to transform the plurality of image coefficients into a plurality of image pixel values.

20. The device of claim 19, wherein
wherein the signal energies comprise at least one of
light,
infrared radiation,
terahertz radiation,
millimeter wave radiation, and
X-ray radiation.
